(19) United States
(12) Patent Application Publication
(10) Pub. No.: US 2007/0105992 A1
(43) Pub. Date: May 10, 2007

(54) Cycloalkyl phosphites as stabilizers for thermoplastic resins

(76) Inventors: Hayder Zahalka, Morgantown, WV (US); Gary Marlin, Morgantown, WV (US)

Correspondence Address: Daniel Reitenbach;CHEMTURA CORPORATION, Benson Road, Middlebury, CT, 06749, US

(21) Appl. No.: 11/267,895

(22) Filed: Nov. 7, 2005

(51) Int. Cl. C08K 5/49

(52) U.S. Cl. 524/115

(57) ABSTRACT

Disclosed herein is a stabilized composition comprising: (A) a polymeric resin, and
(B) a stabilizing amount of a phosphite of the structure 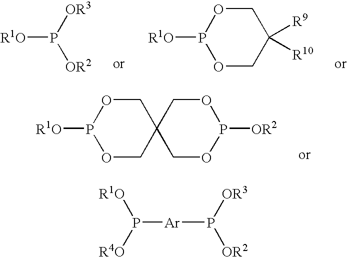 wherein
R¹, R², R³, and R⁴ are independently selected from the group consisting of alkyl moieties and substituted cycloalkyl moieties of the structure 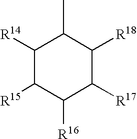 wherein
R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,
R⁹ and R¹⁰ are independently selected from the group consisting of hydrogen and hydrocarbyl, and Ar is an aromatic moiety.

### BACKGROUND OF THE INVENTION

1. Field of the Invention

The present invention relates to compositions and stabilizers for polymeric resin compositions. More particularly, the present invention relates to the use of cycloalkyl phosphites as stabilizers for resin compositions.

2. Description of Related Art

The need for stabilization of polymeric compositions is known, and the use of compounds such as hydroxylamines, amine oxides, lactones, hindered phenolics, and phosphites is also generally known. For example, U.S. Pat. No. 4,403,053 discloses stabilization of polyolefins with a benzotriazole and a phosphite, and U.S. Pat. No. 4,305,866 discloses stabilization of a polyolefin with a phosphite. As a further example, U.S. Pat. No. 4,443,572 discloses stabilization of polyolefins with phosphites, hindered phenols, and thioesters.

The purpose of stabilizers is to prevent deterioration of polymers during processing at high temperatures and also to permit the manufacture of products with increased intrinsic quality because of the enhancement of their resistance to thermal and light degradation during use. In addition, because of these enhanced properties, their versatility is increased and wider use is thereby made possible.

U.S. Pat. No. 3,322,619 discloses the preparation of alkyl cyclohexanones by subjecting alkyl phenols to catalytic hydrogenation to give an alkylcyclohexanol, which is then catalyticallyl dehydrogenated or oxidized with CrO₃ to give the alkylcyclohexanone

U.S. Pat. No. 4,305,866 discloses a process for the preparation of mixed aromatic-aliphatic phosphites. The process involves the reaction of an alkylphenol with diphenyl-(or a lower dialkyl-) pentaerythritol diphosphite.

U.S. Pat. No. 5,142,083 discloses the preoparation of hydrolytically stable phosphite compositions for melt flow and color stabilization of thermoplastics from crude tetrahydroabietyl alcohol. The phosphites may be prepared by reacting the alcohol with an organophosphite, such as by transesterification.

U.S. Pat. Nos. 5,364,895 and 5,438,086 disclose a class of hydrolytically stable bis(aralkylphenyl)pentaerythritol diphosphites, which is suitable as an antioxidant additive in polyolefins, particularly, in polypropylene. The diphosphites are of low volatility, have a high thermal decomposition temperature and resist yellowing when blended into a polyolefin base. A preferred diphosphite is bis(2,4-dicumylphenyl)pentaerythritol diphosphite.

U.S. Pat. No. 5,594,053 discloses aromatic dicyclic phosphites that contain a neo substituted carbon group and stabilizing compositions and stabilized resin containing such phosphite compositions.

U.S. Pat. No. 5,616,767 discloses a process for making 2,2 bisphenyl phosphites and 2,2 biphenyl phosphites that involves reacting phosphorous trichloride with either (a) an aromatic diphenol selected from the group of bisphenyl and biphenyls or (b) a monohydroxy hydrocarbon compound, to induce a first product, and then reacting the first product with the other of (a) and (b) in the presence of an amount of tri-n-alkylamine sufficient to neutralize the hydrochloric acid produced in the second reaction, and utilizing an aromatic liquid hydrocarbon medium and a minimum amount to facilitate precipitation of the resultant aromatic phosphite.

U.S. Pat. No. 5,955,522 discloses a process for the preparation of olefin polymers by polymerization over a transition metallocene catalyst with the addition of at least one phosphorus (III) compound, sterically hindered amine, sterically hindered phenol or acid scavenger, alone or in combination with one another. The polymers obtained in this way are said to be of outstanding stability.

U.S. Pat. No. 6,111,146 discloses surfactants made by (1) alkoxylating an alkylphenol with an alkylene oxide using a standard alkylene catalyst; (2) hydrogenating the alkoxylated alkylphenol until it is either fully or partially saturated using selective catalysts such that the aromaticity of the compound is eliminated; (3) if necessary, further alkoxylating the resulting non-aromatic molecule. The resulting compound is an alkylcyclohexanol alkoxylate for use as emulsifiers, for wetting and penetration, for scouring, and general surface modification.

U.S. Pat. No. 6,214,915 discloses thermoplastic resin compositions that comprise a thermoplastic resin or mixture thereof and a stabilizing amount of an aromatic ketone compound, derivative of an aromatic ketone compound, or an adduct of an aromatic ketone compound, optionally containing a stabilizing amount of a stabilizer or mixture of stabilizers selected from the group consisting of the phenolic antioxidants, the 3-arylbenzofuranones, the hindered amine stabilizers, the ultraviolet light absorbers, the organic phosphorus compounds, the alkaline metal salts of fatty acids, the hydrotalcites, the epoxydized soybean oils, the hydroxylamines, the tertiary amine oxides, thermal reaction products of tertiary amine oxides, and the thiosynergists. The compositions are said to have improved stability against thermal degradation.

U.S. Pat. No. 6,437,194 discloses a preparation process of alkylcyclohexanol alkylene oxide adduct which contains almost no alkylphenol alkylene oxide adduct 1) in the absence of a solvent, 2) in the presence of a saturated hydrocarbon solvent, or 3) in the presence of water. The invention can prepare alkylcyclohexanol alkylene oxide having a 200 ppm or less content of alkylphenol and alkylphenol alkylene oxide adduct. The alkylcyclohexanol alkylene oxide adduct obtained has less ultraviolet absorption and fluorescence due to alkylphenol alkylene oxide adduct and is thus said to be useful for spectrometric analysis of protein and further has excellent properties in the field of detergent and other common uses of surface active agents.

U.S. Pat. No. 6,919,389 discloses a stabilized resin composition comprising a thermoplastic resin and a stabilizing benzimidazole based additive compound. In a second embodiment, the a method to make a stabilized composition comprising a benzimidazole based stabilizing compound and a resin is disclosed, the method comprising mixing the benzimidazole based stabilizing compound with the resin.

U.S. patent application Publication No. 2003/0009061 discloses a preparation process of alkylcyclohexanol alkylene oxide adduct which contains almost no alkylphenol alkylene oxide adduct 1) in the absence of a solvent, 2) in the presence of a saturated hydrocarbon solvent, or 3) in the presence of water. Alkylcyclohexanol alkylene oxide having a 200 ppm or less content of alkylphenol and alkylphenol alkylene oxide adduct can be prepared. The alkylcyclohexanol alkylene oxide adduct obtained in the process of the invention has less ultraviolet absorption and fluorescence due to alkylphenol alkylene oxide adduct and is thus said to be useful for spectrometric analysis of protein and in the field of detergent and other common uses of surface active agents.

U.S. patent application Publication No. 2004/0249030 discloses phosphites comprising substituted or unsubstituted tricyclodecylmethyl groups. The phosphites may also contain substituted and unsubstituted alcohols having about C₆-C₁₈ carbon atoms. The alcohol chain may be aliphatic, arylalkyl, or alkylaryl groups. The method of making of the phosphite composition is also described.

U.S. patent application Publication No. 2005/0009967 discloses a process for the preparation of a neo diol phosphite stabilizer by a direct/solvent-less method, wherein a neoalkyl chlorophosphite is reacted directly with a mono- or di-substituted hydroxylated aromatic compound, for neo diol phosphite product having little or no odor. Also disclosed are polymeric compositions comprising a stabilizing amount of a neo diol phosphite having low to no odor.

French Patent No. 1,427,688 discloses the preparation of ε-caprolactams starting with the hydrogenation of an alkylphenol.

JP 11350344 discloses 1 ow-viscosity lubricant compositions for textiles. The compositions contain C₆₋₂₀ alkyl-substituted cyclohexanol-alkylene oxide adducts. Thus, hydrogenation of an ethylene oxide-nonylphenol adduct (viscosity 228 cP at 25°) gave an ethylene oxide-nonylcyclohexanol adduct (viscosity 189 cP), which was used as a lubricant for polyester yarns showing good spinning property.

JP 2000033255 discloses the use of ethoxylated, propoxylated, or butoxylated C₆₋₂₀-alkylcyclohexanols as emulsifying agents for stable emulsion polymerization and stabilized polymer emulsions.

JP 2000034495 discloses liquid detergent compositions containing alkylcyclohexanol-alkylene oxide adducts.

JP 2000044933 discloses the use of alkoxylated alkylcyclohexanols as antistatic agents.

JP 2000044934 discloses the use of alkoxylated alkylcyclohexanols as antifogging agents for synthetic resin films.

JP 2000072699 discloses the preparation of alkylcyclohexanols by the hydrogenation of alkyl phenols and distillation in the presence of basic compounds.

U.K. Patent No. 1,025,438 discloses the preparation of alkylcyclohexanols by the hydrogenation of alkylphenols at 150-220° and a H partial pressure of 14-210 kg/cm² in an aliphatic hydrocarbon (b. 20-110°).

Tobicik et al., J. Mol. Catal. A, 194:249-254 (2003), studied the hydrogenation of alkyl-substituted phenols in the liquid phase using supported nickel and palladium catalysts (<0.02 mm) in a stirred reactor. Further information regarding hydrogenation can be found in the references listed in this publication.

The disclosures of the foregoing are incorporated herein by reference in their entirety.

### SUMMARY OF THE INVENTION

Tris(nonylphenyl)phosphite (TNPP) is commonly used in combination with a sterically hindered phenol for the stabilization of high density polyethylene (HDPE), linear low density polyethylene (LLDPE), and other polyolefins. Public concern over the use of TNPP in LLDPE for certain applications has prompted polyolefin producers and additive suppliers to search for alternatives to TNPP. The present invention is directed to the use of cycloalkyl phosphites as stabilizers for these and other resin compositions. In a preferred embodiment, such cycloalkyl phosphites are prepared by the hydrogenation of the corresponding phenols followed by reaction with triphenylphosphite (TPP). For example, in a highly preferred embodiment, nonylcyclohexanol is prepared by hydrogenation of nonylphenol, and the product is then reacted with TPP to form the tris(nonylcyclohexyl) phosphite (TNCP). Other methods known in the art for forming the desired phosphite can, of course, by employed.

More particularly, the present invention is directed to a stabilized composition comprising:

(A) a polymeric resin, and

(B) a stabilizing amount of a phosphite of the structure 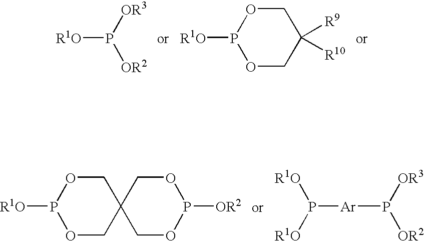
wherein

R¹, R², R³, and R⁴ are independently selected from the group consisting of alkyl moieties and substituted cycloalkyl moieties of the structure 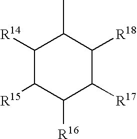
wherein

R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,

R⁹ and R¹⁰ are independently selected from the group consisting of hydrogen and hydrocarbyl, and

Ar is an aromatic moiety.

In another aspect, the present invention is directed to an article of manufacture comprising a stabilized composition comprising:

(A) a polymeric resin, and

(B) a stabilizing amount of a phosphite of the structure 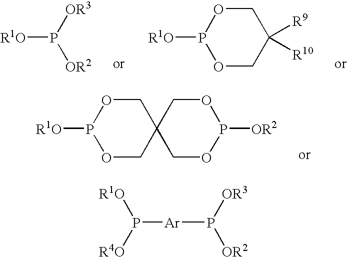
wherein

R¹, R², R³, and R⁴ are independently selected from the group consisting of alkyl moieties and substituted cycloalkyl moieties of the structure 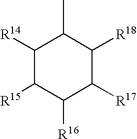
wherein

R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,

R⁹ and R¹⁰ are independently selected from the group consisting of hydrogen and hydrocarbyl, and

Ar is an aromatic moiety.

In still another aspect, the present invention is directed to a method for producing a stabilized resin composition, wherein said method comprises admixing a resin with a stabilizing amount of a phosphite of the structure 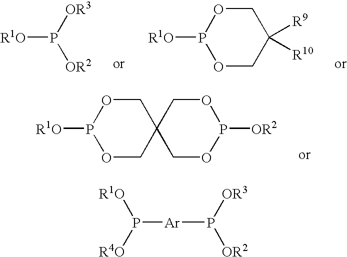
wherein

R¹, R², R³, and R⁴ are independently selected from the group consisting of alkyl moieties and substituted cycloalkyl moieties of the structure 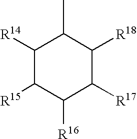
wherein

R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,

R⁹ and R¹⁰ are independently selected from the group consisting of hydrogen and hydrocarbyl, and

Ar is an aromatic moiety.

### DESCRIPTION OF THE PREFERRED EMBODIMENTS

As noted above, the present invention relates to the use of a phosphite of the structure 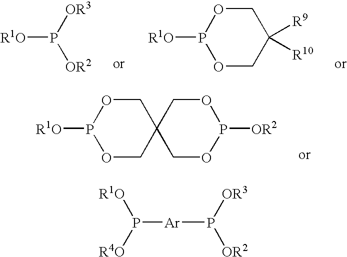
wherein

R¹, R², R³, and R⁴ are independently selected from the group consisting of alkyl moieties and substituted cycloalkyl moieties of the structure 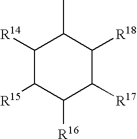
wherein

R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,

R⁹ and R¹⁰ are independently selected from the group consisting of hydrogen and hydrocarbyl, and

Ar is an aromatic moiety.

As employed herein, the term “hydrocarbyl” includes hydrocarbon as well as substantially hydrocarbon groups. “Substantially hydrocarbon” describes groups that contain heteroatom substituents that do not alter the predominantly hydrocarbon nature of the group, nor significantly diminish the effectiveness of the compound as a stabilizer for polymeric resins.

Examples of hydrocarbyl groups include the following:

(1) hydrocarbon substituents, i.e., aliphatic (e.g., alkyl or alkenyl), alicyclic (e.g., cycloalkyl, cycloalkenyl) substituents, aromatic-, aliphatic-, and alicyclic-substituted aliphatic substituents, aromatic substituents, aromatic-, aliphatic-, and alicyclic-substituted aromatic substituents, and the like, as well as cyclic substituents wherein the ring is completed through another portion of the molecule (that is, for example, any two indicated substituents may together form an alicyclic radical);

(2) substituted hydrocarbon substituents, i.e., those substituents containing non-hydrocarbon groups which, in the context of the present invention, do not alter the predominantly hydrocarbon nature of the substituent; those skilled in the art will be aware of such groups (e.g., halo, hydroxy, mercapto, nitro, nitroso, sulfoxy, etc.);

(3) heteroatom substituents, i.e., substituents that will, while having a predominantly hydrocarbon character within the context of the present invention, contain an atom other than carbon present in a ring or chain otherwise composed of carbon atoms (e.g., alkoxy or alkylthio). Suitable heteroatoms will be apparent to those of ordinary skill in the art and include, for example, sulfur, oxygen, nitrogen, and such substituents as, e.g., pyridyl, furyl, thienyl, imidazolyl, etc. Preferably, no more than about 2, more preferably no more than one, hetero substituent will be present for every ten carbon atoms in the hydrocarbyl group. Most preferably, there will be no such heteroatom substituents in the hydrocarbyl group, i.e., the hydrocarbyl group is purely hydrocarbon.

In a preferred embodiment in which R⁴, R⁶, and/or R⁸ are hydrocarbyl, they are alkyl, preferably of from 1 to 18 carbon atoms, e.g., methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, and the like, and mixtures and isomers thereof.

More preferably, where R⁴, R⁶, and/or R⁸ are alkyl, they are alkyl of from 1 to 12 carbon atoms, most preferably 4 to 12 carbon atoms, e.g., t-butyl, nonyl, or dodecyl.

In another preferred embodiment in which R⁴, R⁶, and/or R⁸ are hydrocarbyl, they are aromatic-substituted aliphatic or alicyclic-substituted aliphatic substituents, preferably wherein the aliphatic group is alkyl, as described above. Such aromatic or alicyclic substituents may themselves be substituted. Examples of such compounds include:

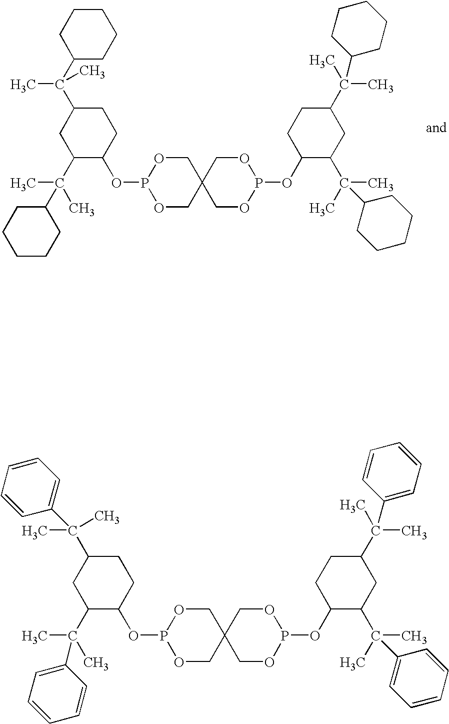

Other particularly preferred stabilizers of the present invention include tris(nonylcyclohexyl)phosphite, tris(2,4-di-t-butylcyclohexyl)phosphite, and tris(dodecylcyclohexyl)phosphite.

Where one of R₁, R₂, and R³ is alkyl, it is preferably selected from the group consisting of alkyl moieties of from one to eighteen carbon atoms, e.g., methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, isomers of the foregoing, and the like.

Where R⁹ and/or R¹⁰ are hydrocarbyl, they are preferably alkyl, as described above.

When an Ar moiety is present in the compounds of the present invention, it is preferably an aromatic moiety of from 6 to 18 carbon atoms, e.g., phenyl, naphthyl, phenanthryl, anthracyl, biphenyl, terphenyl, and the like. Such aromatic moieties can be unsubstituted or can be substituted with any substituent(s) that will not substantially adversely affect the stabilizing properties of the compounds of this invention. Where such an aromatic moiety is present, it is more preferably phenyl or biphenyl, most preferably biphenyl.

One means by which phosphite stabilizers that are used in the practice of the present invention can be made is by reacting a phosphorus trihalide, PZ₃, e.g., phosphorus trichloride, with the appropriate hydrogenated phenol.

The reaction between the hydrogenated phenol and the PZ₃ may be carried out with or without the use of a solvent. Typically, the PZ₃ can be added to the hydrogenated phenol or the hydrogenated phenol can be added to PZ₃. Preferably, the PZ₃ is added to the hydrogenated phenol with the reaction mixture being maintained at a temperature of about 5 to 50° C. This temperature may be controlled by controlling the rate of PZ.₃ addition. A slower addition favors lower temperatures. It is preferred to cool the reaction mixture during the addition. The reaction is quite exothermic in the absence of a solvent, but a temperature moderating effect is produced by the cooling effect of vigorous HZ evolution. Hence, by effective control of the PZ₃ addition, the reaction may be made self-regulating in the temperature range between 5-15° C.

Desirable solvents that may be utilized are neutral solvents. Typical solvents are toluene, heptane, xylene, methylene chloride, chloroform, and benzene. Preferred solvents are methylene chloride, heptane, or xylene.

After the reaction has gone to completion, the bulk of the by-product HZ, such as HCl, may optionally be removed by gently raising the temperature of the product to room temperature to about 50° C. The solvent utilized is removed, typically by application of a vacuum, to yield the product.

Transesterification processes such as those disclosed in Heckenbleikner et al., U.S. Pat. No. 3,056,823, which is incorporated herein by reference, may also be employed. Specifically, the process described by Heckenbleikner et al. involves transesterifying a triaryl phosphite with a monohydroxy hydrocarbon in the presence of a small but catalytically effective amount of a metal alcoholate or metal phenolate.

To avoid contamination, the alcoholate of the particular alcohol to be transesterified is employed. Instead of employing a preformed alcoholate, the alcoholate can be formed in situ by adding the metal, e.g., sodium, potassium or lithium to the alcohol prior to adding the triaryl phosphite. The mono alcohol and triaryl phosphite are reacted in the mol ratio of three mols of the alcohol to one mol of the triaryl phosphite.

The resin, also referred to as a polymeric resin, may be any thermoplastic known in the art, such as polyolefin homopolymers and copolymers, polyesters, polyurethanes, polyalkylene terephthalates, polysulfones, polyimides, polyphenylene ethers, styrenic polymers and copolymers, polycarbonates, acrylic polymers, polyamides, polyacetals and halide-containing polymers. Mixtures of different polymers, such as polyphenylene ether/styrenic resin blends, polyvinyl chloride/ABS or other impact modified polymers, such as methacrylonitrile and alpha-methylstyrene containing ABS, and polyester/ABS or polycarbonate/ABS and polyester plus some other impact modifier may also be used. Such polymers are available commercially or may be made by means well known in the art. However, the stabilizers and stabilizer compositions of the invention are particularly useful in thermoplastic polymers, such as polyolefins, polycarbonates, polyesters, polyphenylene ethers and styrenic polymers, due to the extreme temperatures at which thermoplastic polymers are often processed and/or used.

Polymers of monoolefins and diolefins, for example polypropylene, polyisobutylene, polybutene-1, polymethylpentene-1, polyisoprene, or polybutadiene, as well as polymers of cycloolefins, for instance of cyclopentene or norbornene, polyethylene (which optionally can be crosslinked), for example high density polyethylene (HDPE), low density polyethylene (LDPE) and linear low density polyethylene (LLDPE) may be used. Mixtures of these polymers, for example, mixtures of polypropylene with polyisobutylene, polypropylene with polyethylene (for example PP/HDPE, PP/LDPE) and mixtures of different types of polyethylene (for example LDPE/HDPE), may also be used. Also useful are copolymers of monoolefins and diolefins with each other or with other vinyl monomers, such as, for example, ethylene/propylene, LLDPE and its mixtures with LDPE, propylene/butene-1, ethylene/hexene, ethylene/ethylpentene, ethylene/heptene, ethylene/octene, propylene/isobutylene, ethylene/butane-1, propylene/butadiene, isobutylene, isoprene, ethylene/alkyl acrylates, ethylene/alkyl methacrylates, ethylene/vinyl acetate (EVA) or ethylene/acrylic acid copolymers (EAA) and their salts (ionomers) and terpolymers of ethylene with propylene and a diene, such as hexadiene, dicyclopentadiene or ethylidene-norbornene; as well as mixtures of such copolymers and their mixtures with polymers mentioned above, for example polypropylene/ethylene propylene-copolymers, LDPE/EVA, LDPE/EAA, LLDPE/EVA, and LLDPE/EAA.

The olefin polymers may be produced by, for example, polymerization of olefins in the presence of Ziegler-Natta catalysts optionally on supports such as, for example, MgCl₂, chronium salts and complexes thereof, silica, silica-alumina and the like. The olefin polmers may also be produced utilizing chromium catalysts or single site catalysts, e.g., metallocene catalysts such as, for example, cyclopentadiene complexes of metals such as Ti and Zr. As one skilled in the art would readily appreciate, the polyethylene polymers used herein, e.g., LLDPE, can contain various comonomers such as, for example, 1-butene, 1-hexene and 1-octene comonomers. Preferably, the polymer to be stabilized herein is polyethylene and include, but is not limited to, high density polyethylene (HDPE), low density polyethylene (LDPE) and linear low density polyethylene (LLDPE).

Polymers may also include styrenic polymers, such as polystyrene, poly-(p-methylstyrene), poly-(α-methylystyrene), copolymers of styrene or α-methylstyrene with dienes or acrylic derivatives, such as, for example, styrene/butadiene, styrene/acrylonitrile, styrene/alkyl methacrylate, styrene/maleic anhydride, styrene/maleimide, styrene/butadiene/ethyl acrylate, styrene/acrylonitrile/methylacrylate, mixtures of high impact strength from styrene copolymers and another polymer, such as, for example, from a polyacrylate, a diene polymer or an ethylene/propylene/diene terpolymer; and block copolymers of styrene, such as, for example, styrene/butadiene/styrene, styrene/isoprene/styrene, styrene/ethylene/butylene/styrene or styrene/ethylene/propylene styrene.

Styrenic polymers may additionally or alternatively include graft copolymers of styrene or α-methylstyrene such as, for example, styrene on polybutadiene, styrene on polybutadiene-styrene or polybutadiene-acrylonitrile; styrene and acrylonitrile (or methacrylonitrile) on polybutadiene and copolymers thereof; styrene and maleic anhydride or maleimide on polybutadiene; styrene, acrylonitrile and maleic anhydride or maleimide on polybutadiene; styrene, acrylonitrile and methyl methacrylate on polybutadiene, styrene and alkyl acrylates or methacrylates on polybutadiene, styrene and acrylonitrile on ethylene-propylene-diene terpolymers, styrene and acrylonitrile on polyacrylates or polymethacrylates, styrene and acrylonitrile on acrylate/butadiene copolymers, as well as mixtures thereof with the styrenic copolymers indicated above.

Nitrile polymers are also useful in the polymer composition of the invention. These include homopolymers and copolymers of acrylonitrile and its analogs, such as polymethacrylonitrile, polyacrylonitrile, acrylonitrile/-butadiene polymers, acrylonitrile/alkyl acrylate polymers, acrylonitrile/alkyl methacrylate/butadiene polymers, and various ABS compositions as referred to above in regard to styrenics.

Polymers based on acrylic acids, such as acrylic acid, methacrylic acid, methyl methacrylic acid and ethacrylic acid and esters thereof may also be used. Such polymers include polymethylmethacrylate, and ABS-type graft copolymers wherein all or part of the acrylonitrile-type monomer has been replaced by an acrylic acid ester or an acrylic acid amide. Polymers including other acrylic-type monomers, such as acrolein, methacrolein, acrylamide and methacrylamide may also be used.

Halogen-containing polymers may also be useful. These include resins such as polychloroprene, epichlorohydrin homo- and copolymers, polyvinyl chloride, polyvinyl bromide, polyvinyl fluoride, polyvinylidene chloride, chlorinated polyethylene, chlorinated polypropylene, fluorinated polyvinylidene, brominated polyethylene, chlorinated rubber, vinyl chloride-vinyl acetate copolymers, vinyl chloride-ethylene copolymer, vinyl chloride-propylene copolymer, vinyl chloride-styrene copolymer, vinyl chloride-isobutylene copolymer, vinyl chloride-vinylidene chloride copolymer, vinyl chloride-styrene-maleic anhydride terpolymer, vinyl chloride-styrene-acrylonitrile copolymer, vinyl chloride-butadiene copolymer, vinyl chloride isoprene copolymer, vinyl chloride-chlorinated propylene copolymer, vinyl chloride-vinylidene chloride-vinyl acetate terpolymer, vinyl chloride-acrylic acid ester copolymers, vinyl chloride-maleic acid ester copolymers, vinyl chloride-methacrylic acid ester copolymers, vinyl chloride-acrylonitrile copolymer and internally plasticized polyvinyl chloride.

Other useful polymers include homopolymers and copolymers of cyclic ethers, such as polyalkylene glycols, polyethylene oxide, polypropylene oxide or copolymers thereof with bis-glycidyl ethers; polyacetals, such as polyoxymethylene and those polyoxymethylene which contain ethylene oxide as a comonomer; polyacetals modified with thermoplastic polyurethanes, acrylates or methacrylonitrile containing ABS; polyphenylene oxides and sulfides, and mixtures of polyphenylene oxides with polystyrene or polyamides; polycarbonates and polyester-carbonates; polysulfones, polyethersulfones and polyetherketones; and polyesters which are derived from dicarboxylic acids and diols and/or from hydroxycarboxylic acids or the corresponding lactones, such as polyethylene terephthalate, polybutylene terephthalate, poly-1,4dimethylol-cyclohexane terephthalate, poly-2(2,2,4(4-hydroxyphenyl)-propane) terephthalate and polyhydroxybenzoates as well as block copolyetheresters derived from polyethers having hydroxyl end groups.

Polyamides and copolyamides which are derived from bisamines and dicarboxylic acids and/or from aminocarboxylic acids or the corresponding lactams, such as polyamide 4, polyamide 6, polyamide 6/6, 6/10, 6/9, 6/12 and 4/6, polyamide 11, polyamide 12, aromatic polyamides obtained by condensation of m-xylene bisamine and adipic acid; polyamides prepared from hexamethylene bisamine and isophthalic or/and terephthalic acid and optionally an elastomer as modifier, for example poly-2,4,4 trimethylhexamethylene terephthalamide or poly-m-phenylene isophthalamide may be useful. Further copolymers of the aforementioned polyamides with polyolefins, olefin copolymers, ionomers or chemically bonded or grafted elastomers; or with polyethers, such as for instance, with polyethylene glycol, polypropylene glycol or polytetramethylene glycols and polyamides or copolyamides modified with EPDM or ABS may be used.

Polyolefin, polyalkylene terephthalate, polyphenylene ether and styrenic resins, and mixtures thereof are more preferred, with polyethylene, polypropylene, polyethylene terephthalate, polyphenylene ether homopolymers and copolymers, polystyrene, high impact polystyrene, polycarbonates and ABS-type graft copolymers and mixtures thereof being particularly preferred.

As used herein, by “stabilizing amount” or an “effective amount” of the phosphites of the invention is meant when the polymer composition containing the phosphites of the invention shows improved stability in any of its physical or color properties in comparison to an analogous polymer composition which does not include a phosphite of the invention. Examples of improved stability include improved stabilization against, for example, molecular weight degradation, color degradation, and the like from, for example, melt processing, weathering, and/or long term field exposure to heat, light, and/or other elements. In one example, an improved stability is meant one or both of lower initial color or additional resistance to weathering, as measured, for example, by initial yellowness index (YI), or by resistance to yellowing and change in color, when compared to a composition without the stabilizer additive.

The present compositions may optionally contain an additional stabilizer or mixture of stabilizers selected from the group consisting of the phenolic antioxidants, hindered amine stabilizers, the ultraviolet light absorbers, phosphites, phosphonites, alkaline metal salts of fatty acids, the hydrotalcites, metal oxides, epoxydized soybean oils, the hydroxylamines, the tertiary amine oxides, lactones, thermal reaction products of tertiary amine oxides, and the thiosynergists.

Thus, the resulting stabilized polymeric resin compositions optionally also contain various conventional additives, such as the following:

Antioxidants: Antioxidants may comprise alkylated mono-phenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4 isobutylphenol, 2,6-dicyclopentyl-4-methylphenol, 2-(α-methylcyclohexyl)-4,6 dimethylphenol, 2,6-di-octadecyl-4-methylphenol, 2,4,6,-tricyclohexylphenol, 2,6-di-tert-butyl-4-methoxymethylphenol. Alkylated hydroquinones, for example, 2,6di-tert-butyl-4-methoxyphenol, 2,5-di-tert-butylhydroquinone, 2,5-di-tert-amyl-hydroquinone, 2,6 diphenyl-4-octadecyloxyphenol, may also be used as antioxidants.

Antioxidants used may also comprise hydroxylated thiodiphenyl ethers, for example, 2,2′-thio-bis-(6-tert-butyl-4-methylphenol), 2,2′-thio-bis-(4-octylphenol), 4,4′-thio-bis-(6-tertbutyl-3-methylphenol), and 4,4′-thio-bis-(6-tert-butyl-2-methylphenol).

Alkylidene-bisphenols may be used as antioxidants as, for example, 2,2′-methylene-bis-(6-tert-butyl-4-methylphenol), 2,2′-methylene-bis-(6-tert-butyl-4-ethylphenol), 2,2′-methylene-bis-(4-methyl-6-(α-methylcyclohexyl)phenol), 2,2′-methylene-bis-(4-methyl-6-cyclohexylphenol), 2,2′-methylene-bis-(6-nonyl-4-methylphenol), 2,2′-methylene-bis-(6-nonyl-4-methylphenol), 2,2′-methylene-bis-(6-(α-methylbenzyl)-4-nonylphenol), 2,2′-methylene-bis-(6-(α,α-dimethylbenzyl)-4-nonyl-phenol), 2,2′-methylene-bis-(4,6-di-tert-butylphenol), 2,2′-ethylidene-bis-(6-tert-butyl-4-isobutylphenol), 4,4′methylene-bis-(2,6-di-tert-butylphenol), 4,4′-methylene-bis-(6-tert-butyl-2-methylphenol), 1,1-bis-(5-tert-butyl-4-hydroxy-2-methylphenol)butane, 2,6-di-(3-tert-butyl-5-methyl-2-hydroxybenzyl)-4-methylphenol, 1,1,3-tris-(5-tert-butyl-4-hydroxy-2-methylphenyl)butane, 1,1-bis-(5-tert-butyl-4-hydroxy2-methylphenyl)-3-dodecyl-mercaptobutane, ethyleneglycol-bis-(3,3-bis-(3′-tert -butyl-4′-hydroxyphenyl)-butyrate)-di-(3-tert-butyl-4-hydroxy-5-methylpenyl)-dicyclopentadiene, di-(2-(3′-tert-butyl-2′-hydroxy-5′-methylbenzyl)-6-tert-butyl-4-methylphenyl)terephthalate, and other phenolics, such as monoacrylate esters of bisphenols, such as ethylidiene bis-2,4-di-t-butylphenol monoacrylate ester and esters of 3-5 dibutyl hydroxyphenyl propionic acid. The phenolic antioxidants of particular interest are selected from the group consisting of n-octadecyl 3,5-di-tert-butyl-4-hydroxyhydrocinnamate, neopentanetetrayl tetrakis(3,5-di-tert-butyl-4-hydroxyhydrocinnamate), di-n-octadecyl 3,5-di-tert-butyl-4-hydroxybenzylphosphonate, 1,3,5-tris(3,5-di-tert-butyl-4-hydroxybenzyl)-isocyanurate, thiodiethylene bis(3,5-di-tert-butyl-4-hydroxyhydrocinnamate), 1,3,5-trimethyl-2,4,6-tris(3,5-di-tert-butyl-4-hydroxybenzyl)benzene, 3,6-dioxaoctamethylene bis(3-methyl-5-tert-butyl-4-hydroxyhydrocinnamate), 2,6-di-tert-butyl-p-cresol, 2,2′-ethylidene-bis(4,6-di-tert-butylphenol), 1,3,5-tris(2,6-dimethyl-4-tert-butyl-3-hydroxybenzyl)isocyanurate, 1,1,3-tris(2-methyl-4-hydroxy-5-tert-butylphenyl)butane, 1,3,5-tris[2-(3,5-di-tert-butyl-4-hydroxyhydrocinnamoyloxy)ethyl]isocyanurate, 3,5-di-(3,5-di-tert-butyl-4-hydroxybenzyl)mesitol, hexamethylene bis(3,5-di-tert-butyl-4-hyroxyhydrocinnamate), 1-(3,5-di-tert-butyl-4-hydroxyanilino)-3,5-di(octylthio)-s-triazine, N,N′-hexamethylene-bis(3,5-di-tert-butyl-4-hydroxyhydrocinnamamide), calcium bis(ethyl 3,5-di-tert-butyl-4-hydroxybenzylphosphonate), ethylene bis[3,3-di(3-tert-butyl-4-hydroxyphenyl)butyrate], octyl 3,5-di-tert-butyl-4-hydroxybenzylmercaptoacetate, bis(3,5-di-tert-butyl-4-hydroxyhydrocinnamoyl)hydrazide, and N,N′-bis-[2-(3,5-di-tert-butyl-4-hydroxyhydrocinnamoyloxy)ethyl]-oxamide.

Other antioxidants that may be used include benzyl compounds, for example, 1,3,5-tris-(3,5-di-tert-butyl-4-hydroxybenzyl)-2,4,6-trimethylbenzene, bis-(3,5-di-tert-butyl-4-hydroxybenzyl)sulfide, isooctyl 3,5-di-tert-butyl-4-hydroxybenzyl-mercaptoacetate, bis-(4-tert-butyl-3-hydroxy-2,6-dimethylbenzyl)dithiol-terephthalate, 1,3,5-tris-(3,5-di-tert-butyl-4,10hydroxybenzyl)isocyanurate, 1,3,5-tris-(4-tert-butyl-3-hydroxy-2,6-dimethylbenzyl)isocyanurate, dioctadecyl 3,5-di-tert-butyl-4-hydroxybenzylphosphonate, calcium salt of monoethyl 3,5-di-tertbutyl-4-hydroxybenzylphosphonate, and 1,3,5-tris-(3,5-dicyclohexyl-4-hydroxybenzyl)isocyanurate.

Acylaminophenols may be used as antioxidants, for example, 4-hydroxy-lauric acid anilide, 4-hydroxy-stearic acid anilide, 2,4-bis-octylmercapto-6-(3,5-tert-butyl-4-hydroxyanilino)-s-triazine, and octyl-N-(3,5-di-tert-butyl-4-hydroxyphenyl)-carbamate.

Esters of β-(5-tert-butyl-4-hydroxy-3-methylphenyl)-propionic acid with monohydric or polyhydric alcohols, for example, methanol, diethyleneglycol, octadecanol, triethyleneglycol, 1,6-hexanediol, pentaerythritol, neopentylglycol, tris-hydroxyethyl isocyanurate, thiodiethyleneglycol, and dihydroxyethyl oxalic acid diamide may also be used as antioxidants.

Antioxidants may also comprise amides of β-(3,5-di-tert-butyl-4hydroxyphenol)-propionic acid, for example, N,N′-di-(3,5-di-tert-butyl-4-hydroxyphenylpropionyl)-hexamethylendiamine, N,N′-di-(3,5-di-tert-butyl-4-hydroxyphenylpropionyl)trimethylenediamine, and N,N′-di(3,5-di-tert-butyl-4-hydroxyphenylpropionyl)-hydrazine.

UV absorbers and light stabilizers may comprise 2-(2′-hydroxyphenyl)-benzotriazoles, for example, the 5′-methyl-,3′5′-di-tert-butyl-,5′-tert-butyl-,5′(1,1,3,3-tetramethylbutyl)-, 5-chloro-3′,5′-di-tert-butyl-,5-chloro-3′-tert-butyl-5′-methyl-3′-sec-butyl-5′-tert-butyl-,4′-octoxy,3′,5′-di-tert-amyl-3′,5′-bis-(α,α-dimethylbenzyl)-derivatives. 2-Hydroxy-benzophenones, for example, the 4-hydroxy-4-methoxy-, 4-octoxy, 4-decyloxy-, 4dodecyloxy-,4-benzyloxy,4,2′,4′-trihydroxy- and 2′-hydroxy-4,4′-dimethoxy derivatives may also be used as UV absorbers and light stabilizers. UV absorbers and light stabilizers may also comprise esters of substituted and unsubstituted benzoic acids, for example, phenyl salicylate, 4-tert-butylphenyl salicylate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate, and hexadecyl-3,5-di-tert-butyl-4-hydroxybenzoate.

Acrylates, for example, α-cyano-β,β-diphenylacrylic acid-ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, and N -(β-carbomethoxy-β-cyano-vinyl)-2-methyl-indoline may be used as UV absorbers and light stabilizers.

Other examples for UV absorbers and light stabilizers include nickel compounds, for example, nickel complexes of 2,2′-thio-bis(4-(1,1,1,3-tetramethylbutyl)-phenol), such as the 1:1 or 1:2 complex, optionally with additional ligands such as n-butylamine, triethanolamine or N-cyclohexyl-diethanolamine, nickel dibutyldithiocarbamate, nickel salts of 4-hydroxy-3,5-di-tert-butylbenzylphosphonic acid monoalkyl esters, such as of the methyl, ethyl, or butyl ester, nickel complexes of ketoximes such as of 2-hydroxy-4-methyl-penyl undecyl ketoxime, nickel complexes of 1-phenyl-4-lauroyl-5-hydroxy-pyrazole, optionally with additional ligands.

Sterically hindered amines may be used as UV absorbers and light stabilizers as for example bis (2,2,6,6-tetramethylpiperidyl)-sebacate, bis-5 (1,2,2,6,6-pentamethylpiperidyl)-sebacate, n-butyl-3,5-di-tert-butyl-4-hydroxybenzyl malonic acid bis(1,2,2,6,6,-pentamethylpiperidyl)ester, condensation product of 1-hydroxyethyl-2,2,6,6-tetramethyl-4-hydroxy-piperidine and succinic acid, condensation product of N,N′-(2,2,6,6-tetramethylpiperidyl)-hexamethylendiamine and 4-tert-octylamino-2,6-dichloro-1,3,5-s-triazine, tris-(2,2,6,6-tetramethylpiperidyl)-nitrilotriacetate, tetrakis-(2,2,6,6-tetramethyl-4-piperidyl)-1,2,3,4-butane-tetra-arbonic acid, 1,1′(1,2-ethanediyl)-bis-(3,3,5,5-tetramethylpiperazinone). These amines, typically called HALS (Hindered Amine Light Stabilizers), include butane tetracarboxylic acid 2,2,6,6-tetramethyl piperidinol esters. Such amines include hydroxylamines derived from hindered amines, such as di(1-hydroxy-2,2,6,6-tetramethylpiperidin-4-yl)sebacate; 1-hydroxy-2,2,6,6-tetramethyl-4-benzoxypiperidine; 1-hydroxy-2,2,6,6-tetramethyl-4-(3,5-di-tert-butyl-4-hydroxy hydrocinnamoyloxy)-piperdine; and N-(1-hydroxy-2,2,6,6-tetramethyl-piperidin-4-yl)-epsiloncaprolactam.

UV absorbers and light stabilizers may also comprise oxalic acid diamides, for example, 4,4′-di-octyloxy-oxanilide, 2,2′-di-octyloxy-5′,5′-ditert-butyloxanilide, 2,2′-di-dodecyloxy-5′,5′di-tert-butyl-oxanilide, 2-ethoxy-2′-ethyl-oxanilide, N,N′-bis(3-dimethylaminopropyl)-oxalamide, 2-ethoxy-5-tert-butyl-2′-ethyloxanilide and its mixture with 2-ethoxy-2′-ethyl-5,4-di-tert-butyloxanilide and mixtures of ortho- and para-methoxy-, as well as of o- and p-ethoxy-, disubstituted oxanilides.

UV absorbers and light stabilizers also include hydroxyphenyl-s-triazines, as, for example, 2,6-bis-(2,4-dimethylphenyl)-4-(2-hydroxy-4-octyloxyphenyl)-s-triazine, 2,6-bis(2,4-dimethylphenyl)-4-(2,4-dihydroxyphenyl)-s-triazine; 5 2,4-bis(2,4-dihydroxyphenyl)-6-(4-chlorophenyl)-s-triazine; 2,4-bis(2-hydroxy-4-(2-hydroxyethoxy)phenyl)-6-(4-chlorophenyl)-s-triazine; 2,4-bis(2-hydroxy-4-(2-hydroxyethoxy)phenyl)-6-phenyl-s-triazine; 2,4-bis(2-hydroxy-4-(2-hydroxyethoxy)-phenyl)-6-(2,4-dimethylphenyl)-s-triazine; 2,4-bis(2-hydroxy-4-(2-hydroxyethoxy)phenyl)-6-(4-bromo-phenyl)-s-triazine; 2,4-bis(2-hydroxy-4-(2-acetoryethoxy)phenyl)-6-(4-chlorophenyl)-s-triazine, 2,4-bis(2,4-dihydroxyphenyl)-6-(2,4-dimethylphenyl)-1-s-triazine.

Metal deactivators as, for example, N,N′-diphenyloxalic acid diamide, N-salicylal-N′-salicyloylhydrazine, N,N′-bis-salicyloylhydrazine, N,N′-bis-(3,5-di-tert-butyl-4-hydrophenylpropionyl)-2-hydrazine, salicyloylamino-1,2,4-triazole, and bis-benzyliden-oxalic acid dihydrazide, may also be used.

Phosphites and phosphonites, as, for example, triphenyl phosphite, diphenylalkyl phosphites, phenyldialkyl phosphites, tris(nonyl-phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, 2,4,6-tri-tert-butylphenyl-2-butyl-2-ethyl-1,3-propanediol phosphite, bis(2,4-di-tert-butylphenyl)pentaerythritol diphosphite, bis(2,4-di-cumyl)pentaerithritol diphosphite, tristearyl sorbitol triphosphite, and tetrakis(2,4-di-tert-butylphenyl)4,4′-biphenylene diphosphonite may be used in some embodiments of the invention in addition to the phosphites of the invention.

Peroxide scavengers, as, for example, esters of beta-thiodipropionic acid, for example the lauryl, stearyl, myristyl or tridecyl esters, mercaptobenzimidazole or the zinc salt of 2-mercaptobenzimidazole, zinc-dibutyldithiocarbamate, dioctadecyldisulfide, and pentaerythrotetrakis-(β-dodecylmercapto)-propionate may be used.

Hydroxylamines, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecyl hydroxylamine, N-heptadecyl-N-octadecylhydroxylamine, and N,N-dialkylhydroxylamine derived from hydrogenated tallow amine may also be used in some embodiments of the present invention.

Nitrones, for example, N-benzyl-α-phenyl nitrone, N-ethyl-α-methyl nitrone, N-octyl-α-heptyl nitrone, N-lauryl-α-undecyl nitrone, N-tetradecyl-α-tridecyl nitrone, N-hexadecyl-α-pentadecyl nitrone, N-octadecyl-α-heptadecylnitrone, N-hexadecyl-α-heptadecylnitrone, N-octadecyl-α-pentadecyl nitrone, N-heptadecyl-α-heptadecyl nitrone, N-octadecyl-α-hexadecyl nitrone, and nitrone derived from N,N-dialkylhydroxylamine derived from hydrogenated tallow amine may also be used.

Polyamide stabilizers, for example, copper salts in combination with iodides and/or phosphorus compounds and salts of divalent manganese.

Basic co-stabilizers, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, Ca stearate, calcium stearoyl lactate, calcium lactate, Zn stearate, Mg stearate, for example, Na ricinoleate and K palmitate, antimony pyrocatecholate or zinc pyrocatecholate, including neutralizers, such as hydrotalcites and synthetic hydrotalcites, and Li, Na, Mg, Ca, and Al hydroxy carbonates may be used in other embodiments of the present invention, as, also, MgZn hydroxycarbonates, MgAl hydroxycarbonates and AlZn hydroxycarbonates, and metal oxides, such as ZnO, MgO, and CaO.

Nucleating agents, for example, 4-tert-butylbenzoic acid, adipic acid, diphenylacetic acid, sodium salt of methylene bis-2,4-dibutylphenyl, cyclic phosphate esters, sorbitol tris-benzaldehyde acetal, and the sodium salt of bis(2,4-di-t-butylphenyl)phosphate or the Na salt of ethylidene bis(2,4-di-t-butyl phenyl)phosphate may also be used in some embodiments.

Fillers and reinforcing agents may comprise, for example, calcium carbonate, silicates, glass fibers, asbestos, talc, kaolin, mica, barium sulfate, metal oxides and hydroxides, carbon black and graphite.

Other additives may be, for example, plasticizers, epoxidized vegetable oils, such as epoxidized soybean oils, lubricants, emulsifiers, pigments, optical brighteners, flameproofing agents, anti-static agents, blowing agents and thiosynergists, such as dilaurythiodipropionate or distearylthiodipropionate, and the like.

The additives and stabilizers described herein are preferably present in an amount effective to improve composition stability. When one of the aforementioned additives and stabilizers is utilized, the amount is generally less than about 5 weight percent based on the weight of the resin and is preferably at least about 50 ppm based on the weight of the resin. The stabilizer combinations of this invention stabilize resins especially during high temperature processing with relatively little change in melt index and/or color, even though the polymer may undergo a number of extrusions. The instant stabilizers may readily be incorporated into the resins by conventional techniques, at any convenient stage prior to the manufacture of shaped articles therefrom. For example, the stabilizer may be mixed with the resin in dry powder form, or a suspension or emulsion of the stabilizer may be mixed with a solution, suspension, or emulsion of the polymer. The stabilized compositions of the invention may optionally also contain from about 0.001 to about 5%, preferably from about 0.0025 to about 2%, and especially from about 0.005% to about 1%, by weight of various conventional additives, such as those described previously, or mixtures thereof.

The stabilizers of this invention advantageously assist with the stabilization of polymer resin compositions especially in high temperature processing against changes in melt index and/or color, even though the polymer resin may undergo a number of extrusions. The stabilizers of the present invention may readily be incorporated into the resin compositions by conventional techniques, at any convenient stage prior to the manufacture of shaped articles therefrom. For example, the stabilizer may be mixed with the resin in dry powder form, or a suspension or emulsion of the stabilizer may be mixed with a solution, suspension, or emulsion of the polymer.

The compositions of the present invention can be prepared by a variety of methods, such as those involving intimate admixing of the ingredients with any additional materials desired in the formulation. Suitable procedures include solution blending and melt blending. Because of the availability of melt blending equipment in commercial polymer processing facilities, melt processing procedures are generally preferred. Examples of equipment used in such melt compounding methods include: co-rotating and counter-rotating extruders, single screw extruders, disc-pack processors and various other types of extrusion equipment. In some instances, the compounded material exits the extruder through small exit holes in a die and the resulting strands of molten resin are cooled by passing the strands through a water bath. The cooled strands can be chopped into small pellets for packaging and further handling.

All of the ingredients may be added initially to the processing system, or else certain additives may be pre-compounded with each other or with a portion of the polymeric resin to make a stabilizer concentrate. Moreover, it is also sometimes advantageous to employ at least one vent port to allow venting (either atmospheric or vacuum) of the melt. Those of ordinary skill in the art will be able to adjust blending times and temperatures, as well as component addition location and sequence, without undue additional experimentation.

While the stabilizers of this invention may be conveniently incorporated by conventional techniques into polymeric resins before the fabrication thereof into shaped articles, it is also possible to apply the instant stabilizers by a topical application to the finished articles. Articles may comprise the instant stabilizer compounds and resins and may be made into, for example, head lamp covers, roofing sheets, telephone covers, aircraft interiors, building interiors, computer and business machine housings, automotive parts, and home appliances. The articles may be made by extrusion, injection molding, roto-molding, compaction, and other methods. This may be particularly useful with fiber applications where the instant stabilizers are applied topically to the fibers, for example, by way of a spin finish during the melt spinning process.

The stabilizer compounds of the present invention may also be useful in thermoset resin compositions such as polyurethanes, epoxides, melamine, and phenolics; and may be useful in thermoset/plastic blends, and may be present at the levels set out above for thermoplastic resin compositions.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

Yellowness Index and Melt Flow Rate Examples

In the examples, a base resin comprising 100 parts by weight of unstabilized linear low density polyethylene with 0.05 part by weight of octadecyl 3,5-di-(tert)-butyl-4-hydroxyhydrocinnamate, with or without 0.05 part of zinc stearate is blended with a test stabilizer (as indicated in the tables below) using a Turbula Blender for 30 minutes or high speed mixer.

The test stabilizer, if liquid, is pre-blended with the resin and mixed well using a Turbula Blender. The stabilized resin formulation is extruded at 100 rotations per minute from a 1 inch (2.54 centimeter) diameter extruder at 450° F. (230° C.) in a Killion extruder. After each of the first, third and fifth extrusions, resin pellets are compression molded into 125 mil (3.2 millimeter) thick plaques at 370° F. (188° C.).

The specimen samples are measured for yellowness index (YI). Low YI values indicate less yellowing. The lower the YI value, the more effectively does the stabilizer system prevent yellowing and damage of the organic polymeric material. The melt flow rate (in grams/10 minutes) per ASTM-D-1238 (190° C./2.16 Kg, 190 C.°/21.6 Kg referred to as I-2 and I-21 respectively in the following tables, is also measured on the pellets after the first, third and fifth extrusions. The closer the melt flow rate is after the fifth extrusion relative to the melt flow rate after the first extrusion, the more effective is the process stabilization achieved.

An aging study was also conducted comparing polymer resin compositions comprising the phosphite of the present invention with phosphites of the prior art. In this study, immediately after compounding, the pellets are stored away for 1 month at 60° C. and 80% relative humidity (RH). In the examples, all aged pellets are oven dried for 2 hours at 100° C. They are then multipassed through the extruder as described above.

Gas-fade testing was carried out usint AATCC test method 164-1987 at 60° and samples were also exposed to the environmental pollutants NO_{x.}

### Example 1

### Procedure for the Preparation of Tris(nonylcyclohexyl)phosphite

Equipment:

A glass-lined reactor equipped with mechanical agitation and a packed distilling column with a reflux head, condenser, and receiver with warm water (about 50° C.) and capable of vacuum less than 5 mm Hg, 190° C. and of with nitrogen available to break the vacuum. A filter is also needed to clarify the product.

The reaction is as follows:

Charge:

| | |
|---|---|
| Triphenyl Phosphite | 93.3 lb |
| Nonylcyclohexanol | 245 lb |
| Sodium Methoxide | 0.1 lb |

Steps:

1. Make sure reactor is clean and dry. Pull down vacuum to less than 5 mm Hg, then break vacuum with nitrogen.

2. Charge alcohol, triphenyl phosphite and sodium methoxide catalyst.

3. Begin heating and reducing pressure to 40 mm Hg. Maximum kettle temperature is 180° C.

4. Set for total reflux. When phenol begins to reflux, continue for about 15 minutes.

5. Begin taking off phenol, allowing some reflux. Continue unless vapor temperature (at constant pressure) begins to rise. If it does, go to total reflux until it drops back.

6. When boil-up drops off; put on total reflux, then reduce the pressure gradually to maximum capability.

7. Resume take off when distillate temperature stabilizes. When the kettle temperature reaches 180° C., continue to take off phenol as it boils up until it appears that no more phenol is going to come off. (possibly 1-5 hours).

8. By-pass the column to strip as much excess alcohol off as will come off at a maximum temperature of 190° C. and best vacuum.

9. Cool and break vacuum with nitrogen.

10. At about 100° C., add filter aid.

11. At about 90° C., start circulating through a sparkler filter (or the equivalent).

12. When clear and free of foreign material, drum off product.

Theoretical Yield:

| | |
|---|---|
| Tris(nonylcyclohexyl)phosphite | 212.6 lb. |
| Phenol | 84.9 lb. |
| Excess nonylcyclohexanol | 40.8 lb. |

### Example 2

### Procedure for the Preparation of Tris(dodecylcyclohexyl)phosphite

Equipment:

A glass-lined reactor equipped with mechanical agitation and a packed distilling column with a reflux head, condenser, and receiver with warm water (about 50° C.) and capable of vacuum less than 5 mm Hg, 200° C. and of with nitrogen available to break the vacuum. A filter is also needed to clarify the product.

The reaction is as follows:

Charge:

| | |
|---|---|
| Triphenyl Phosphite | 93.3 lb |
| Dodecylcyclohexanol | 291 lb |
| Sodium Methoxide | 0.2 lb |

Steps:

1. Make sure reactor is clean and dry. Pull down vacuum to less than 5 mm Hg, then break vacuum with nitrogen.

2. Charge alcohol, triphenyl phosphite and sodium methoxide catalyst.

3. Begin heating and reducing pressure to 40 mm Hg. Maximum kettle temperature is 185° C.

4. Set for total reflux. When phenol begins to reflux, continue for about 15 minutes.

5. Begin taking off phenol, allowing some reflux. Continue unless vapor temperature (at constant pressure) begins to rise. If it does, go to total reflux until it drops back.

6. When boil-up drops off; put on total reflux, then reduce the pressure gradually to maximum capability.

7. Resume take off when distillate temperature stabilizes. When the kettle temperature reaches 185° C., continue to take off phenol as it boils up until it appears that no more phenol is going to come off. (possibly 1-5 hours).

8. By-pass the column to strip as much excess alcohol off as will come off at a maximum temperature of 200° C. and best vacuum.

9. Cool and break vacuum with nitrogen.

10. At about 100° C., add filter aid.

11. At about 90° C., start circulating through a sparkler filter (or the equivalent).

12. When clear and free of foreign material, drum off product.

Theoretical Yield:

| | |
|---|---|
| Tris(dodecylcyclohexyl)phosphite | 250.7 lb. |
| Phenol | 84.9 lb. |
| Excess dodecylcyclohexanol | 48.4 lb. |

### Examples 3-8

### Evaluation of Cycloalkylphosphites in Metallocene-Produced LLDPE and Ziegler-Natta Produced LLDPE

Formulations (ppm)

| | Example | | | | | |
|---|---|---|---|---|---|---|
| | 3 (control) | 4 | 5(control) | 6(control) | 7 | 8(control) |
| m-LLDPE | Yes | Yes | Yes | No | No | No |
| ZN- | No | No | No | Yes | Yes | Yes |
| LLDPE | | | | | | |
| A | 500 | 500 | 500 | 500 | 500 | 500 |
| B | 1500 | | | 1500 | | |
| C | | 1500 | | | 1500 | |
| D | | | 1500 | | | 1500 |
| Zn | | | | 500 | 500 | 500 |
| Stearate | | | | | | |

m-LLDPE is metallocene-produced LLDPE
ZN-LLDPE is Ziegler-Natta produced LLDPE
A is octadecyl-3,5-di-tert-butyl-4-hydroxyhydrocinnamate
B is tris(nonylphenyl)phosphite (Control)
C is tris(nonylcyclohexyl)phosphite (Invention)
D is trilauryl phosphite (Control)

Melt Flow (I-2) Data

| | Example | | | | | |
|---|---|---|---|---|---|---|
| | 3(control) | 4 | 5(control) | 6(control) | 7 | 8(control) |
| Com- | 0.922 | 0.936 | 0.937 | 1.233 | 1.178 | 1.158 |
| pound | | | | | | |
| 1^{st} Pass | 0.907 | 0.932 | 0.943 | 1.200 | 1.204 | 1.193 |
| 3^{rd} Pass | 0.897 | 0.912 | 0.939 | 1.221 | 1.164 | 1.159 |
| 5^{th} Pass | 0.856 | 0.809 | 0.944 | 1.169 | 1.168 | 1.258 |

Melt Flow (I-21) Data

| | Example | | | | | |
|---|---|---|---|---|---|---|
| | 3(control) | 4 | 5(control) | 6(control) | 7 | 8(control) |
| Compound | 14.620 | 14.746 | 14.748 | 29.395 | 28.413 | 29.455 |
| 1^{st} Pass | 14.862 | 14.961 | 15.075 | 29.646 | 28.937 | 29.972 |
| 3^{rd} Pass | 14.764 | 14.882 | 15.129 | 29.98 | 29.555 | 29.363 |
| 5^{th} Pass | 14.634 | 14.370 | 15.203 | 30.323 | 29.656 | 29.975 |

Yellowness Index (YI)

| | Example | | | | | |
|---|---|---|---|---|---|---|
| | 3(control) | 4 | 5(control) | 6(control) | 7 | 8(control) |
| Com- | −1.29 | −1.25 | −1.33 | −1.13 | −1.23 | −1.40 |
| pound | | | | | | |
| 1^{st} Pass | −1.18 | −1.19 | −1.21 | −0.88 | −1.08 | −1.11 |
| 3^{rd} Pass | −0.97 | −1.06 | −1.10 | −0.87 | −1.23 | −1.32 |
| 5^{th} Pass | −0.92 | −1.00 | −1.03 | −0.70 | −1.11 | −1.29 |

Gas Fading at 60° C.: Effect of NOₓ
Exposure on YI m-LLDPE

| | | Example | | |
|---|---|---|---|---|
| | | 3 | 4 | 5 |
| 0 | Days | −1.10 | −1.24 | −1.25 |
| 3 | | −0.88 | −1.23 | −1.04 |
| 8 | | −0.75 | −0.71 | 0.13 |
| 10 | | −0.72 | −0.35 | 0.58 |
| 14 | | −0.22 | 0.78 | 1.69 |
| 17 | | 0.56 | 1.48 | 2.19 |
| 21 | | 2.11 | 2.38 | 2.58 |

Effect of Oven Aging (60°) on YI m-LLDPE

| | | Example | | |
|---|---|---|---|---|
| | | 3 | 4 | 5 |
| 0 | Days | −1.14 | −1.23 | −1.23 |
| 7 | | −1.06 | −1.18 | −1.20 |
| 14 | | −0.90 | −1.06 | −1.09 |
| 21 | | −0.74 | −0.92 | −0.93 |
| 28 | | −0.59 | −0.78 | −0.81 |
| 35 | | −0.55 | −0.77 | −0.82 |

Gas Fading @ 60° C.: Effect of NOₓ
Exposure on YI ZN-LLDPE

| | | Example | | |
|---|---|---|---|---|
| | | 6 | 7 | 8 |
| 0 | Days | −0.88 | −1.07 | −1.11 |
| 4 | | −0.85 | −1.14 | −0.75 |
| 7 | | −0.55 | −0.56 | 0.36 |
| 12 | | −0.14 | 0.60 | 2.44 |
| 14 | | 0.18 | 1.00 | 3.27 |
| 18 | | 1.02 | 1.97 | 4.97 |
| 21 | | 1.68 | 2.62 | 5.93 |
| 25 | | 2.18 | 2.53 | 6.08 |

Effect of Oven Aging (60° C.) on YI for ZN-LLDPE

| Days | 6(control) | 7 | 8(control) |
|---|---|---|---|
| 0 | −0.97 | −1.20 | −1.25 |
| 7 | −0.67 | −1.01 | −0.96 |
| 14 | −0.39 | −0.60 | −0.63 |
| 21 | 0.23 | −0.34 | −0.17 |
| 28 | 0.42 | −0.03 | 0.21 |
| 35 | 0.92 | 0.28 | 0.58 |
| 42 | 1.22 | 0.47 | 0.86 |

Polymer performance evaluation employing a phosphite within the scope of the invention demonstrated a better balance of properties and exhibited improved performance attributes in ZN-LLDPE and m-LLDPE. Generally, for applications, e.g., film, where gas fading properties are an important criterion, the phosphite of the present invention showed superior color retention when the polymer samples were exposed to NOₓ, gases. That is, optimal performance for a given application can be achieved with this tailor-made liquid phosphite for better performance, less discoloration during processing, NOₓ, exposure, and thermal aging.

In view of the many changes and modifications that can be made without departing from principles underlying the invention, reference should be made to the appended claims for an understanding of the scope of the protection to be afforded the invention.

What is claimed is:

1. A stabilized composition comprising:
(A) a polymeric resin, and
(B) a stabilizing amount of a phosphite of the structure 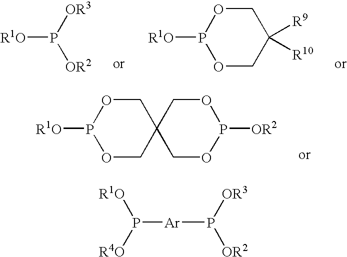
wherein
R¹, R², R³, and R⁴ are independently selected from the group consisting of alkyl moieties and substituted cycloalkyl moieties of the structure 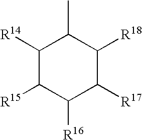
wherein
R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,
R⁹ and R¹⁰ are independently selected from the group consisting of hydrogen and hydrocarbyl, and
Ar is an aromatic moiety.

2. The composition of claim 1 wherein at least one of R¹⁴, R¹⁶, and R¹⁸ is alkyl.

3. The composition of claim 2 wherein the alkyl comprises from 1 to 18 carbon atoms.

4. The composition of claim 3 wherein the alkyl is selected from the group consisting of tert.-butyl, nonyl, and dodecyl.

5. The composition of claim 1 wherein at least one of R¹⁴, R¹⁶, and R¹⁸ is an aromatic-substituted aliphatic or alicyclic-substituted aliphatic substituent.

6. The composition of claim 5 wherein the aliphatic substituent is alkyl.

7. The composition of claim 5 wherein the aromatic or alicyclic substituents are themselves substituted.

8. The composition of claim 1 wherein the phosphite is selected from the group consisting of tris(nonylcyclohexyl)phosphite, tris(2,4-di-t-butylcyclohexyl)phosphite, and tris(dodecylcyclohexyl)phosphite.

9. An article of manufacture comprising a stabilized composition comprising:
(A) a polymeric resin, and
(B) a stabilizing amount of a phosphite of the structure 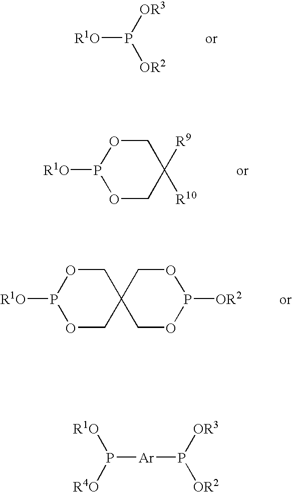
wherein
R¹, R², R³, and R⁴ are independently selected from the group consisting of alkyl moieties and substituted cycloalkyl moieties of the structure 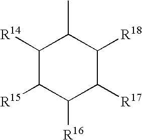
wherein
R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,
R⁹ and R¹⁰ are independently selected from the group consisting of hydrogen and hydrocarbyl, and
Ar is an aromatic moiety.

10. The article of claim 9 wherein at least one of R¹⁴, R⁶, and R⁸ is an alkyl of from 1 to 18 carbon atoms.

11. The article of claim 9 wherein at least one of R⁴, R¹⁶, and R¹⁸ is an aromatic-substituted aliphatic or alicyclic-substituted aliphatic substituent.

12. The article of claim 9 wherein the phosphite is selected from the group consisting of tris(nonylcyclohexyl)phosphite, tris(2,4-di-t-butylcyclohexyl)phosphite, and tris(dodecylcyclohexyl)phosphite.

13. A method for producing a stabilized resin composition, wherein said method comprises admixing a resin with a stabilizing amount of a phosphite of the structure 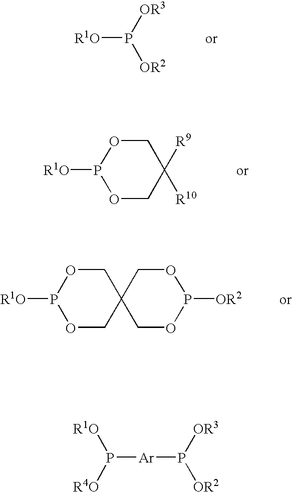
wherein
R¹, R², R³, and R⁴ are independently selected from the group consisting of alkyl moieties and substituted cycloalkyl moieties of the structure 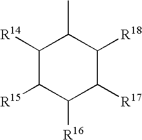
wherein
R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,
R⁹ and R¹⁰ are independently selected from the group consisting of hydrogen and hydrocarbyl, and
Ar is an aromatic moiety.

14. The method of claim 13 wherein at least one of R¹⁴, R¹⁶, and R¹⁸ is alkyl.

15. The method of claim 14 wherein the alkyl comprises from 1 to 18 carbon atoms.

16. The method of claim 15 wherein the alkyl is selected from the group consisting of tert.-butyl, nonyl, and dodecyl.

17. The method of claim 13 wherein at least one of R¹⁴, R¹⁶, and R¹⁸ is an aromatic-substituted aliphatic or alicyclic-substituted aliphatic substituent.

18. The method of claim 17 wherein the aliphatic substituent is alkyl.

19. The method of claim 17 wherein the aromatic or alicyclic substituents are themselves substituted.

20. The method of claim 13 wherein the phosphite is selected from the group consisting of tris(nonylcyclohexyl)phosphite, tris(2,4-di-t-butylcyclohexyl)phosphite, and tris(dodecylcyclohexyl)phosphite.

21. A composition comprising:
(A) a phosphite stabilizer of the structure 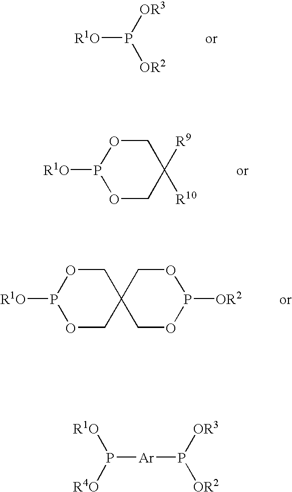
wherein
R¹, R², R³, and R⁴ are independently selected from the group consisting of alkyl moieties and substituted cycloalkyl moieties of the structure 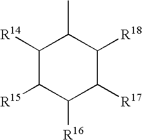
wherein
R¹⁴, R¹⁵, R¹⁶, R¹⁷, and R¹⁸ are independently selected from the group consisting of hydrogen and hydrocarbyl, provided that at least one of R¹⁴, R¹⁵, R¹⁶, R¹⁷, and R¹⁸ is not hydrogen and that no more than one of R¹, R², and R³ is alkyl,
R⁹ and R¹⁰ are independently selected from the group consisting of hydrogen and hydrocarbyl, and
Ar is an aromatic moiety; and
(B) at least one additional stabilizer selected from the group consisting of the phenolic antioxidants, hindered amine stabilizers, the ultraviolet light absorbers, phosphites, phosphonites, alkaline metal salts of fatty acids, the hydrotalcites, metal oxides, epoxydized soybean oils, the hydroxylamines, the tertiary amine oxides, lactones, thermal reaction products of tertiary amine oxides, and the thiosynergists.

22. The composition of claim 21 further comprising a polymeric resin.
